(19) United States
(12) Patent Application Publication
(10) Pub. No.: US 2020/0027272 A1
(43) Pub. Date: Jan. 23, 2020

(54) ROOM-SCALE VIRTUAL REALITY MOBILE UNIT

(71) Applicant: Exit Reality VR, Inc., San Francisco, CA (US)

(72) Inventors: Gregory Scott Abbott, Los Angeles, CA (US); Zachary Rubin, Seattle, WA (US); Yehonatan Shai Koenig, Berkeley, CA (US); William John Reges, IV, Tustin, CA (US); Ari Harald Schindler, Woodland Hills, CA (US); Ilya Druzhnikov, San Francisco, CA (US)

(21) Appl. No.: 16/513,574

(22) Filed: Jul. 16, 2019

Related U.S. Application Data
(60) Provisional application No. 62/717,465, filed on Aug. 10, 2018.
(60) Provisional application No. 62/717,482, filed on Aug. 10, 2018.
(60) Provisional application No. 62/703,000, filed on Jul. 25, 2018.
(60) Provisional application No. 62/717,657, filed on Aug. 10, 2018.
(60) Provisional application No. 62/724,363, filed on Aug. 29, 2018.
(60) Provisional application No. 62/700,721, filed on Jul. 19, 2018.
(60) Provisional application No. 62/721,905, filed on Aug. 23, 2018.
(60) Provisional application No. 62/722,062, filed on Aug. 23, 2018.

(51) Int. Cl. G06T 19/00; G06F 3/0481; G06F 3/01; G06K 9/00

(52) U.S. Cl. CPC G06T 19/006; G06T 19/003; G06K 9/00597; G06F 3/011; G06F 3/04815

(57) ABSTRACT

A virtual reality system, including one or more modular walls configured to define an interior area, at least one modular wall having a monochromatic interior surface, a camera positioned within the interior area, the camera configured to capture an image of a player with the monochromatic interior surface as a background, one or more processors configured to generate a virtual scene, to receive the image of the player, and to generate a composite image including at least a portion of the image of the player composited into the virtual scene, and a display configured to receive and display the composite image. The one or more modular walls may define a number of interior areas for multiple players.

### PRIORITY

This disclosure claims benefit of U.S. Provisional Application No. 62/717,465, titled “NOVEL WIRELESS UNIT ENABLING PUBLIC FACING MULTI-USER VIRTUAL REALITY EXPERIENCES,” filed on Aug. 10, 2018; U.S. Provisional Application No. 62/717,482, titled “NOVEL MOBILE MODULAR UNIT ENABLING LOCATION BASED ROOM SCALE VIRTUAL REALITY EXPERIENCES,” filed on Aug. 10, 2018; U.S. Provisional Application No. 62/703,000, titled “NOVEL AERIAL SUSPENSION DEVICE FOR VIRTUAL REALITY HEADSET HDMI CABLE MANAGEMENT,” filed on Jul. 25, 2018; U.S. Provisional Application No. 62/717,657, titled “NOVEL COLLAPSABLE MOBILE VIRTUAL REALITY UNIT ENABLING LOCATION BASED ROOM SCALE VIRTUAL REALITY EVENTS, filed on Aug. 10, 2018; U.S. Provisional Application No. 62/724,363, titled “NOVEL MODULAR UNIT ENABLING SINGLE AND MULTIPLAYER VIRTUAL REALITY EXPERIENCES IN AN ARCADE SETTING,” filed on Aug. 29, 2018; U.S. Provisional Application No. 62/700,721, titled “NOVEL DEVICE CONVERTING BIOMETRIC DATA INTO AUDIO VISUAL CONTENT DISPLAYED THROUGH A VIRTUAL REALITY HEAD-MOUNTED DISPLAY UNIT,” filed on Jul. 19, 2018; U.S. Provisional Application No. 62/721,905, titled “USER AUTHENTICATION DEVICE REGARDING VIRTUAL REALITY GAMBLING EXPERIENCES,” filed on Aug. 23, 2018; and U.S. Provisional Application No. 62/722,062, titled “DEVICE ENABLING A VIRTUAL REALITY USER'S IN-EXPERIENCE PURCHASES THAT DOES NOT COMPROMISE IMMERSION,” filed on Aug. 23, 2018, each of which is incorporated herein by reference in its entirety.

### FIELD OF THE INVENTION

This disclosure is directed to a mobile or modular unit for housing virtual reality equipment that enables single and multiplayer virtual reality experiences, and, more particularly, to a mobile or modular unit that can display mixed reality images for spectators to view while one or more players are participating in virtual reality experiences.

### BACKGROUND

Virtual reality technology and supporting infrastructure have emerged and spread through numerous directions in both the consumer and professional markets, particularly within the location based entertainment sector. Location based entertainment companies employing virtual reality must often choose between a stationary virtual reality entertainment experience unit of generally high-quality, or a generally lower-quality mobile virtual reality experience unit that travels to other locations to fulfill event requests.

For example, a stationary virtual reality entertainment experience unit can often accommodate multiple players using the same or different virtual reality experiences simultaneously. This sort of unit requires a large footprint, e.g. twenty feet in length by twenty feet in width and approximately eight feet in height. A mobile virtual reality entertainment unit, on the other hand, is often simply a tripod device that is aesthetically displeasing to end players, compromises functionality of virtual reality experiences, and leaves little or no space for a sponsor's branding. These mobile units often support only one player at a time. If they do support multiple players, the players are often insufficiently separated due to a lack of space and bump into one another—possibly damaging each other and the virtual reality equipment. Current virtual reality systems are unable to safely support multiple players, while also allowing quick assembling and disassembly for transporting from location to location.

Embodiments of the disclosure address these and other deficiencies of the prior art.

### BRIEF DESCRIPTION OF THE DRAWINGS

Aspects, features and advantages of embodiments of the present disclosure will become apparent from the following description of embodiments in reference to the appended drawings in which:

FIG. 1 depicts an illustrative example of a mobile unit enabling location based room-scale virtual reality experiences according to various embodiments of the disclosure.

FIG. 2 depicts some of the components and implementation methods of positioning and constructing the walls of a mobile unit enabling location based room-scale virtual reality experiences according to various embodiments of the disclosure.

FIG. 3 depicts some of the components and implementation methods of positioning and constructing the floor of a mobile unit enabling location based room-scale virtual reality experiences according to various embodiments of the disclosure.

FIG. 4 depicts some of the components and implementation methods of positioning and constructing the components of a floor of a mobile unit enabling location based room-scale virtual reality experiences according to various embodiments of the disclosure.

FIG. 5 depicts some of the components and implementation methods of positioning and constructing the hardware and software components of a control tower of a mobile unit enabling location based room-scale virtual reality experiences according to various embodiments of the disclosure.

FIG. 6 depicts some of the components and implementation methods of the means of selecting a virtual reality experience via a mobile unit enabling location based room-scale virtual reality experiences according to various embodiments of the disclosure.

FIG. 7 depicts some of the components and implementation methods of positioning and constructing the storage compartment of a mobile unit enabling location based room-scale virtual reality experiences according to various embodiments of the disclosure.

FIG. 8 illustrates an example of a cable management device according to various embodiments of the disclosure.

FIG. 9 illustrates an example of the cable management device of FIG. 7 positioned along a mounting surface.

FIG. 10 depicts from a front perspective an illustrative example of a mobile unit enabling location based room-scale virtual reality events according to various embodiments of the disclosure.

FIGS. 11A and 11B depict left side and frontal perspectives of a control tower of the mobile unit of FIG. 9 according to various embodiments of the disclosure.

FIGS. 12A and 12B depict left side and frontal perspectives of a control tower of the mobile unit of FIG. 9 according to various embodiments of the disclosure.

FIG. 13 depicts an illustrative example of a modular unit enabling single and multiplayer virtual reality experiences in an arcade setting according to various embodiments of the disclosure.

FIG. 14 depicts an example of a multiplayer virtual reality experience in an arcade setting according to various embodiments of the disclosure.

FIG. 15 depicts another example of a multiplayer virtual reality experience in an arcade setting according to various embodiments of the disclosure.

FIG. 16 depicts a block diagram for generating mixed reality images for display on one of the mobile units.

FIG. 17 depicts another example of a multiplayer virtual reality experience in an arcade setting according to various embodiments of the disclosure.

FIG. 18 depicts an interior view of the front side of an example computer system for virtual reality experiences according to various embodiments of the disclosure.

FIG. 19 depicts an interior view of the backside of an example computer system for virtual reality experiences according to various embodiments of the disclosure.

FIG. 20 is a flow chart illustrating an operation for selecting a virtual reality experience by a player according to various embodiments of the disclosure.

FIG. 21 illustrates the conversion of biometric data to audio visual content according to various embodiments of the disclosure.

FIG. 22 illustrates an example of how the audio visual content generated by a data conversion unit from biometric data may be used in the virtual reality experience according to various embodiments of the disclosure.

FIG. 23 is a flow chart illustrating an operation from a player's perspective when using the biometric data as part of the virtual reality experience according to various embodiments of the disclosure.

FIG. 24 is a flow chart illustrating an operation for converting the biometric data for the virtual reality experience according to various embodiments of the disclosure.

FIG. 25 illustrates an example of a fingerprint detection device for collection biometric data according to various embodiments of the disclosure.

FIG. 26 is a flow chart illustrating an example operation for authenticating a player for various virtual reality experiences according to various embodiments of the disclosure.

FIG. 27 is a flow chart illustrating an example of linking a personal account to biometric data according to various embodiments of the disclosure.

FIG. 28 is a flow chart illustrating an example of making an in-experience purchase according to various embodiments of the disclosure.

### DESCRIPTION

Embodiments of the disclosure provide a thrilling and differentiated virtual reality experience using various wall configurations, camera placements, display placements, and mixed reality to provide a compelling experience to spectators watching players participating in a virtual reality experience.

Additionally, embodiments of the disclosure improve the efficiency of the operation of the virtual reality entertainment system, both in moving the system and managing the system while in operation. As will be detailed below, embodiments of the disclosure include features aimed at improving the safety of players and spectators, ease of disassembly, transport and reassembly, cable management, efficient use of space to maximize revenue per square foot, and the ability to provide a turnkey solution to customers who have expertise in running an amusement business but may not have the time to perform system integration of components from various sources.

The terminology used herein is for the purpose of describing particular embodiments only and is not intended to be limiting of the present disclosure. As used herein, the term “and/or” includes any and all combinations of one or more of the associated listed terms. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which the present disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the present disclosure, it will be understood that a number of techniques and steps are disclosed. Each of these has individual benefit and can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the present disclosure and the claims.

In the following description, for purposes of explanation, numerous specific details are set forth in order to provide a thorough understanding of the present disclosure. It will be evident to one skilled in the art, however, that the present disclosure may be practiced without these specific details.

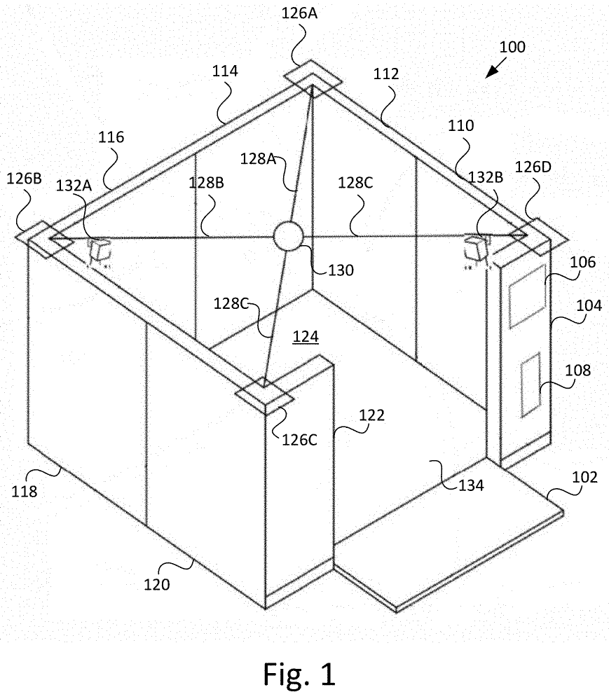

FIG. 1 depicts an illustrative example of a mobile unit 100 enabling location based room-scale virtual reality experiences according to various embodiments described herein. The mobile unit 100 may be modular in form such that it can be deconstructed into a number of panels and be reconstructed into a unit supporting room-scale virtual reality experiences.

In some embodiments, the mobile unit 100 may include an entry ramp 102, which may be in some embodiments an Americans with Disabilities Act (“ADA”) compliant ramp. The ramp 102 may be removable. The mobile unit 100 can also include a control tower 104 housing a monitor system 106, which may be a touchscreen or standard monitor system, and a computer system 108. Two right wall panels 110 and 112, two rear wall panels 114 and 116, two left wall panels 118 and 120 may provide walls for the mobile unit 100.

Although two wall panels are shown on each of the right wall, left wall, and rear wall, embodiments of the disclosure are not limited to such, and only a single wall panel may be used on each of the right wall, left wall, and rear wall, or more than two wall panels may be used on the right wall, left wall, and the rear wall, including any combination of wall panels. In some embodiments, an interior surface of at least one of the walls of the mobile unit 100 is monochrome, such as either blue or green. That is, if the right wall is composed of two right wall panels 110 and 112, both right wall panels would be monochrome. However, the monochrome wall is not limited to the right wall and may be any or all of the interior walls of the mobile unit 100. The mobile unit 100 also includes a storage tower 122 and a floor 124. However, in some embodiments, a floor 124 is not provided.

The mobile unit 100 also includes cable management system fasteners 126A-D, cable management ropes or wires 128A-D, and cable management ring 130, to connect to the virtual reality equipment, which will be discussed in more detail below. The mobile unit 100 also includes cameras 132A and 132B. Positioned in this manner, in some embodiments, the mobile unit 100 can create a floor space of sixty four square feet with a height of eight feet, which is sufficient to enable room-scale virtual reality experiences.

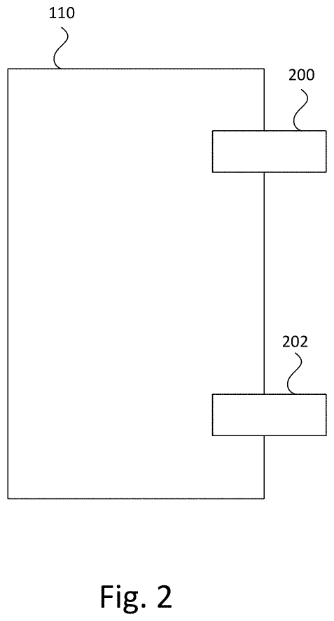

FIG. 2 depicts an example of the wall panel 110. The wall panel 110 may be equipped with modular attachment hinges and/or fastening clasps 200 and 202. Although only wall panel 110 is shown, the attachment hinges 200 and 202 may be included on each of the wall panels 110, 112, 114, 116, 118, and 120, the control tower 104 and the storage tower 122. The modular attachment hinges 200 and 202 allow for positioning and constructing the walls of the mobile unit 100 to enable location based room-scale virtual reality experiences according to various embodiments described herein. The hinges 200 and 202 facilitate the construction, deconstruction, and modular adaptation of mobile room-scale virtual reality units.

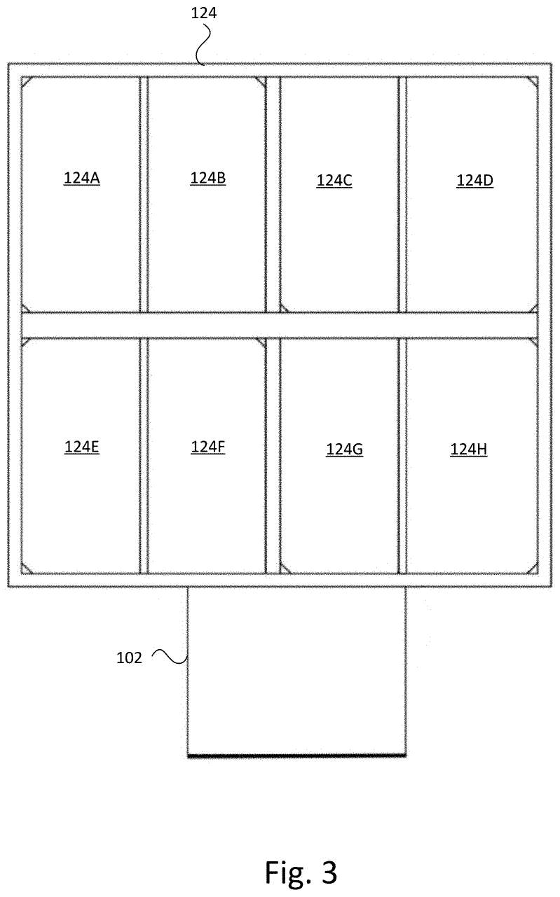

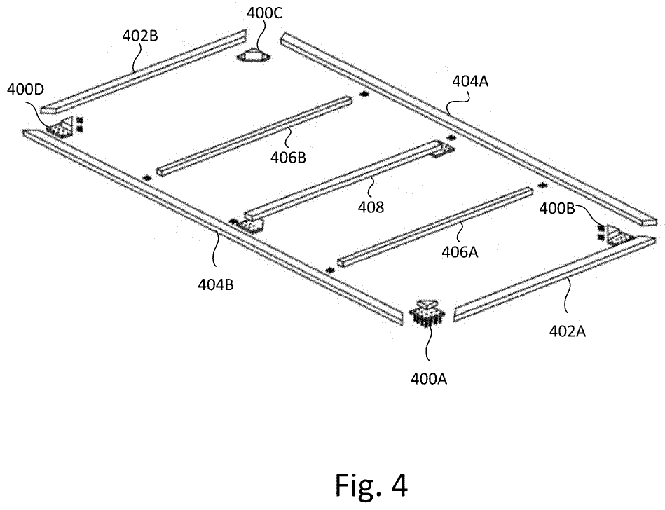

FIG. 3 depicts an example of the floor 124, if provided in the mobile unit 100. The floor 124 may be composed of a number of modular floor panels 124A-H. The entry ramp 102 may be connected to the floor 124. FIG. 4 depicts an example of one of the modular floor panels 124A-H of FIG. 3. Each of the modular floor panels may include exterior frame fastening devices 400A-D, which can fasten the exterior frames 402A-B with the exterior frames 404A-B. The modular floor panels may also include internal joists 406A-B and 408.

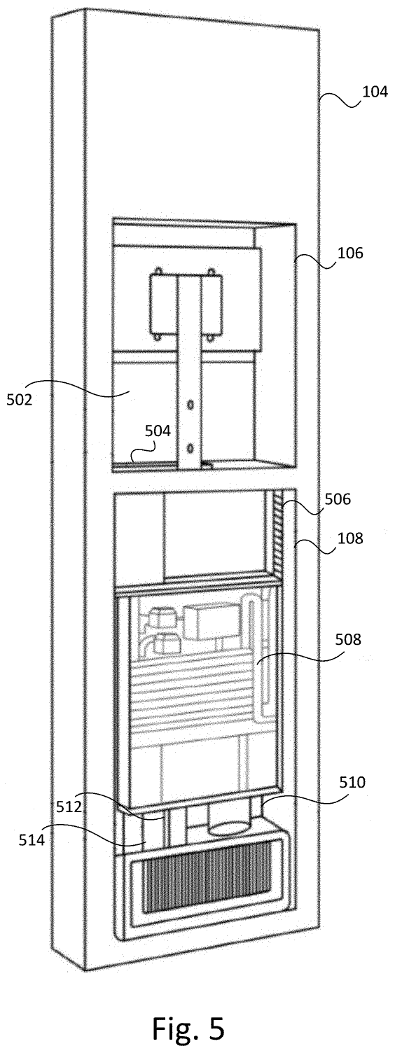

FIG. 5 depicts an example of an interior-facing side of the control tower 104 according to some embodiments of the disclosure. The monitor system 106 of the control tower 104 can include a monitor 502 and a monitor support 504. The monitor 502 may be a touchscreen monitor and/or may be connected to any other type of user input, such as a mouse, keyboard, etc. The monitor 502 faces away toward an exterior-facing side of the control tower 104. The computer system 108 may include a power strip 506, a computer 508, and fans 510. The computer system 108 may also include an LED system 512 and lower cooling vents 514.

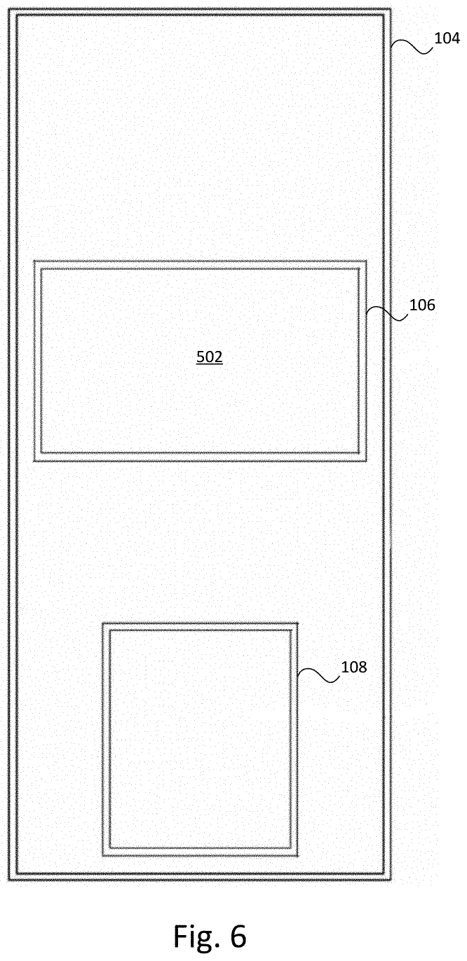

FIG. 6, on the other hand, depicts an example of an exterior-facing side of the control tower 104 according to some embodiments of the disclosure. The control tower 104 includes the front side of the monitor 502 and the front side of the computer system 108.

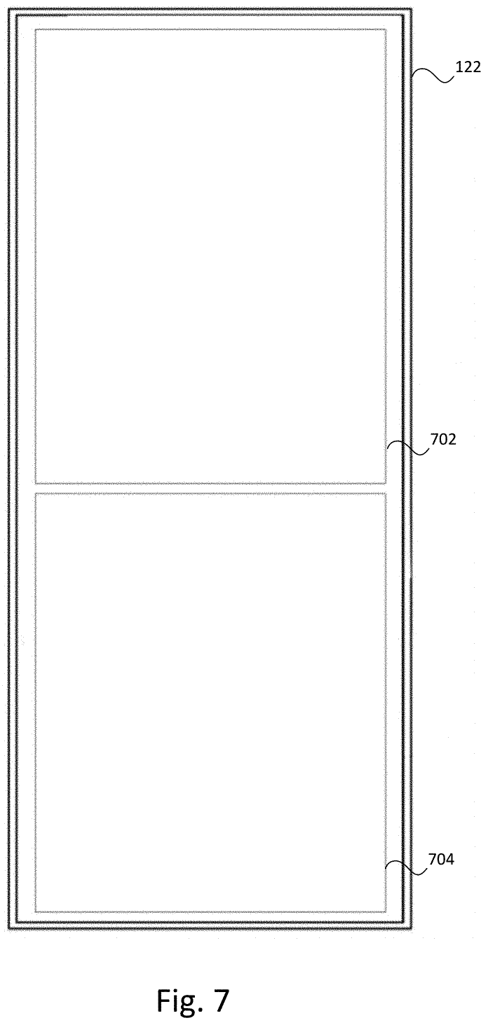

FIG. 7 depicts an example of an interior-facing side of the storage tower 122. In some embodiments, the storage tower 122 may include an interior-facing upper storage tray 702 and an interior-facing lower storage tray 704. The upper storage tray 702 may house, for example, virtual reality equipment, while the lower storage tray 704 may house additional equipment, including sanitary wipes and/or any other equipment needed.

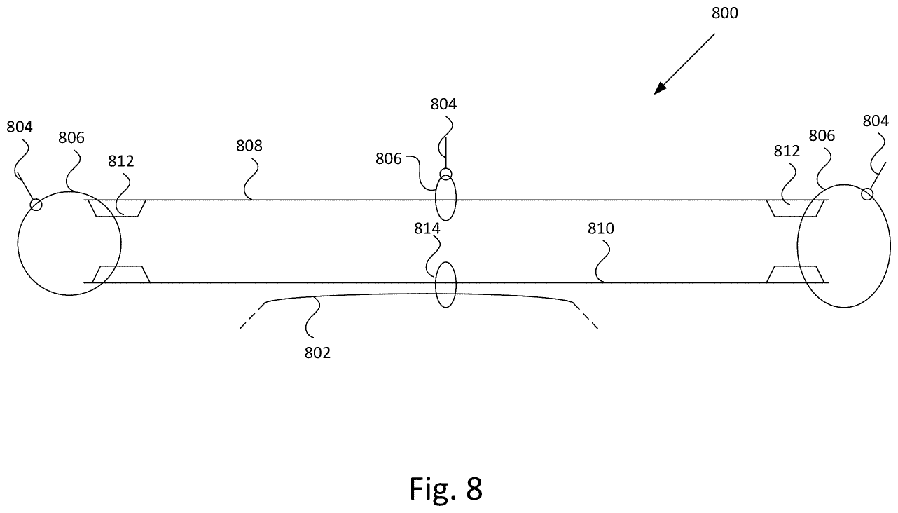

As mentioned above, the mobile unit 100 may include a cable management system 800, an example of which is illustrated in FIG. 8. The cable management system 800 can manage a connection cable 802 that connects a virtual reality headset to computer system 108 to allow a player wearing the virtual reality headset to have a full range of motion without compromising the player's safety, immersive experience, or the supporting virtual reality infrastructure.

The cable management system 800 may be suspended from a ceiling of the mobile unit 100 by a number of eye hook screws 804. In FIG. 8, three eye hook screws 804 are attached to a mounting surface and/or ceiling of the mobile unit. Embodiments of the disclosure, however, are not limited to this configuration and any number of eye hook screws 804 may be used depending on the size of the mobile unit 100. Connected to each of the eye hook screws 804 may be a metal ring 806. An upper cable 808 and a lower cable 810, located on the same axis, can attach to each of the metal rings 806 connected to the outer ends of the cables 806 and 808 via a clamp 812. The upper cable 808 is threaded through the middle metal ring 806.

Another ring 812 may be threaded through the lower cable 810, as well as the connection cable 802. The ring 814 can move along the lower cable 810 with the connection cable 802 so that the connection cable 802 is supported in the cable management system 800 and moves freely with the player, but also maintains the connection cable 802 to prevent it from being tangled on the ground or around the player. A retraction device (not shown) may be attached to the end of the connection cable 802 to retract and extend the connection cable 802 as the player moves about the mobile unit 100. In some embodiments, the retraction device includes a spring or other device that allows movement when the connection cable 802 is pulled, but retracts when the cable is no longer pulled.

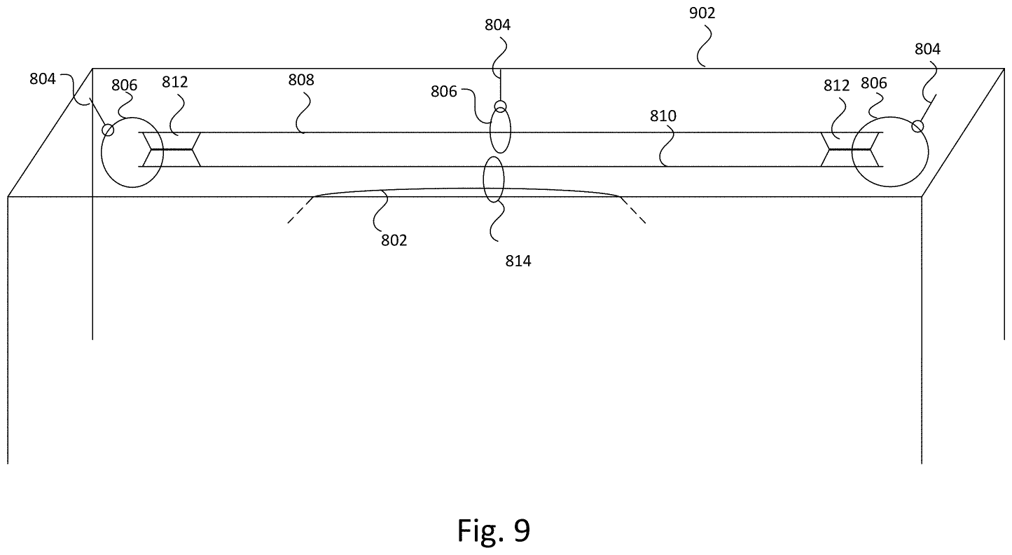

FIG. 9 illustrates a side profile of the cable management system 800 mounted in a portion of a mobile unit 100. The mobile unit 100 may include a mounting surface or ceiling 902 to receive each of the eye hook screws 804. In some embodiments, the two outer eye hook screws 804 are attached to the mounting surface 902 at an approximately 45 degree angle, while the middle eye hook screw 804 is attached at a 90 degree angle. FIG. 8 illustrates the clamps 812 open, while FIG. 9 illustrates the clamps 812 closed to attach the cables 808 and 810 to the metal rings 806.

In some embodiments, the room-scale virtual reality device may be a mobile unit which can house a fully operable room-scale virtual reality experience. That is, in this embodiment, the mobile unit 1000 may collapse and fold into itself and the exterior of the mobile unit 1000 may form a protective case during transportation and storage. When collapsed and folded, mobile unit 1000 may be transported by a single individual.

In some embodiments, the mobile unit 1000 may collapse and fold into two units, each approximately two and a half feet wide by two and sixty-five hundredths feet long and four feet high. Embodiments of the disclosure, however, are not limited to these dimensions. These two units may be clasped together and can be rolled on their wheels, or the unit may be transported on a palette. When fully constructed and operable, the mobile unit 1000 can form an environment enabling room-scale virtual reality experiences specifically suited for events.

In some embodiments, when fully formed, the mobile unit 100 may be eight and a half feet wide by eight and a half feet high. However, embodiments of the disclosure are not limited to a mobile unit 1000 of this size and may be smaller or larger.

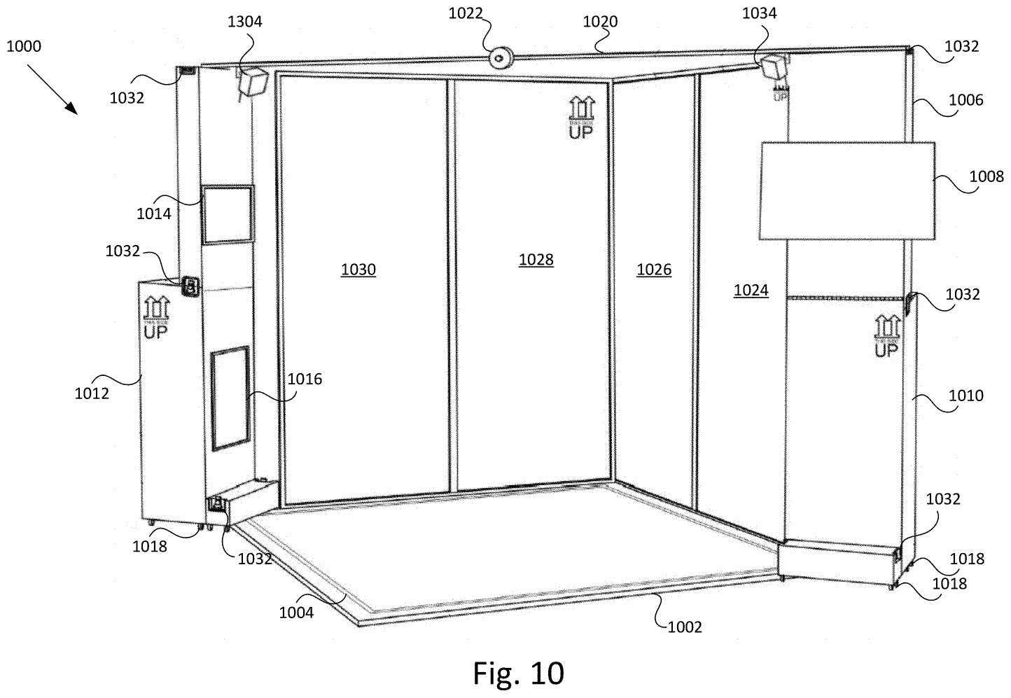

FIG. 10 depicts a front perspective view of the mobile unit 1000. The mobile unit 1000 can include a floor 1002. In some embodiments, the floor 1002 may include LED lighting 1004 either built into the floor 1002 or LED lighting strips 1004 are positioned around or near the edges of the floor 1002. The remainder of the floor 1002 may be similar to floor 124 shown in FIG. 2, with or without the ramp 102. Similar to mobile unit 100, the mobile unit 1000 may have a first control tower 1006 having a detachable TV monitor 1008 and virtual reality equipment storage unit 1010, as well as a second control tower 1012 having a monitor 1014, which may be built-in or detachable, and a virtual reality supporting computer 1016, which also may be built-in or detachable.

Both control towers 1006 and 1012 may have a number of wheels 1018 for movement of the control towers 1006 and 1012. A metal beam 1020 may be positioned across two corners of the mobile unit 1000, such as between the two control towers 1006 and 1012. In some embodiments, the metal beam 1020 is attached to the control towers 1006 and 1012 by clamps. The metal beam 1020 may include a cable management dispenser 1022. A cable (not shown) connected to a virtual reality helmet and the virtual reality support computer 1016 may be threaded through the cable management dispenser to guide the cable when a player is immersed in a virtual reality experience with the helmet. However, a cable management system as shown in FIGS. 8 and 9 may also be used.

The mobile unit 1000 may also include a number of wall panels 124, 126, 128, and 130. Each of the wall panels 124, 126, 128, and 130 may attached to an adjacent wall panel 124, 126, 128, and 130, and/or a control tower 1006 and 1012. Each of the wall panels 124, 126, 128, and 130 may be similar to the wall panel 110 shown in FIG. 2, and include two clasps 200 and 202 to attach to each other. The control towers 1006 and 1012 may include a number of latches 1032 to facilitate expansion of the control towers 1006 and 1012 and to collapse the control towers 1006 and 1012. Cameras 1034 may also be attached to the metal beam 1020 to facilitate the virtual reality experiences.

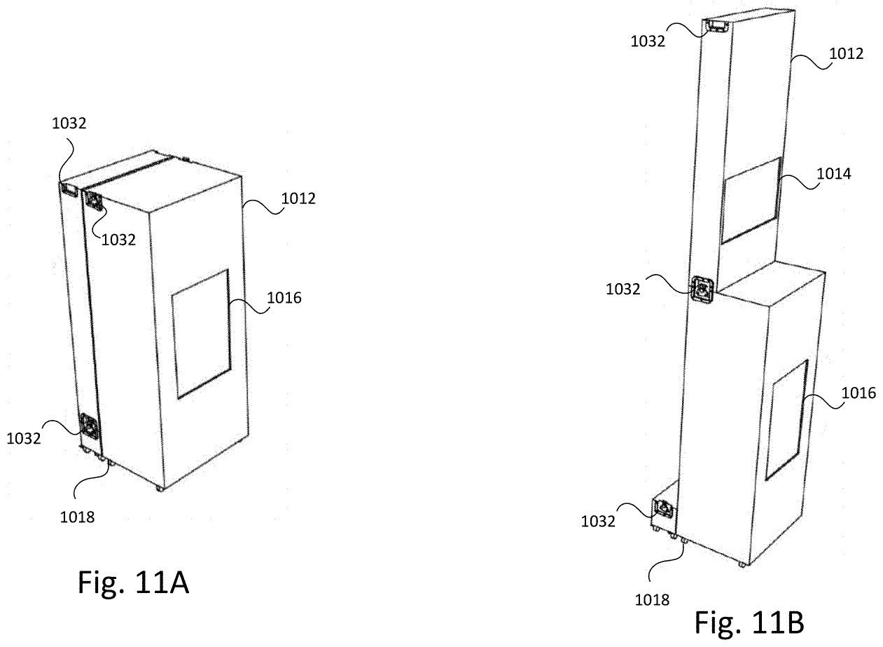

FIGS. 11A and 11B illustrate an example of the control tower 1012 in both the collapsed form and the extended form. As seen in FIGS. 11A and 11B, the control tower 1012 includes a number of latches 1032. The latches 1032 are used to assist in forming or collapsing the control tower 1012. The top and bottom latches 1032 are connected when the control tower 1012 is collapsed and in its mobile form. Wheels 1018 may be used to transport the control tower 1012. The top and bottom latches 1032 are disconnected and the middle latches 1032 are connected when the control tower 1012 is in its extended form for use in the mobile unit 1000. Latches 1032 may be any type of latch that connects to a corresponding latch.

Although the left side perspective is shown in FIGS. 11A and 11B, the right side of the control tower 1012 may contain latches 1032 in similar locations as the left side. That is, top, middle, and bottom latches 1032 are provided on the right side to assist in collapsing or extending the control tower 1012.

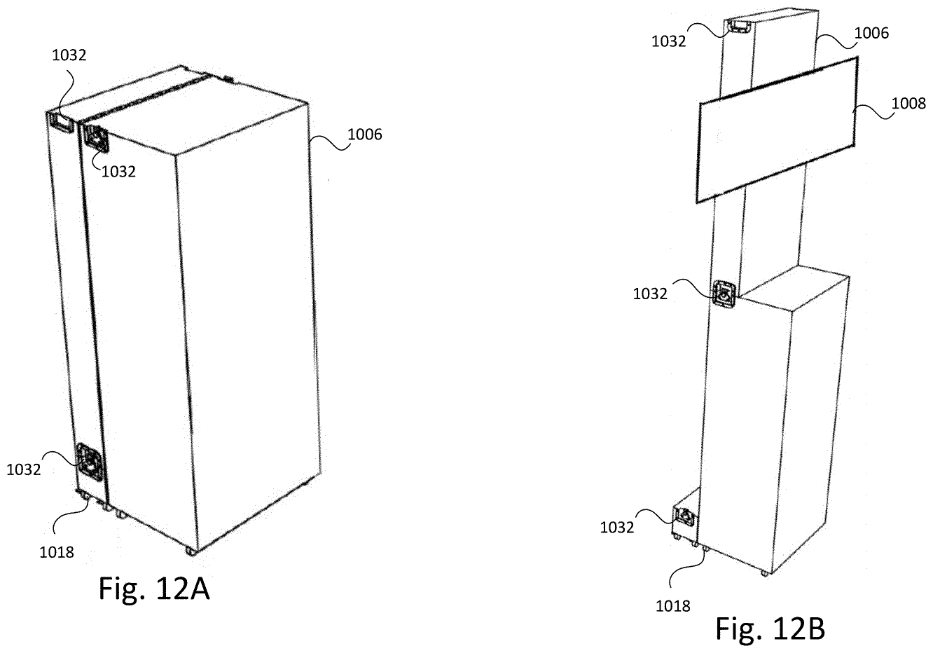

FIGS. 12A and 12B illustrate an example of the control tower 1006 in both the collapsed form and the extended form. As seen in FIGS. 12A and 12B, the control tower 1006 includes a number of latches 1032. The latches 1032 are used to assist in forming or collapsing the control tower 1006. The top and bottom latches 1032 are connected when the control tower 1006 is collapsed and in its mobile form. Wheels 1018 may be used to transport the control tower 1006. The top and bottom latches 1032 are disconnected and the middle latches 1032 are connected when the control tower 1006 is in its extended form for use in the mobile unit 1000. Latches 1032 may be any type of latch that connects to a corresponding latch.

Although the left side perspective is shown in FIGS. 12A and 12B, the right side of the control tower 1006 may contain latches 1032 in similar locations as the left side. That is, top, middle, and bottom latches 1032 are provided on the right side to assist in collapsing or extending the control tower 1006.

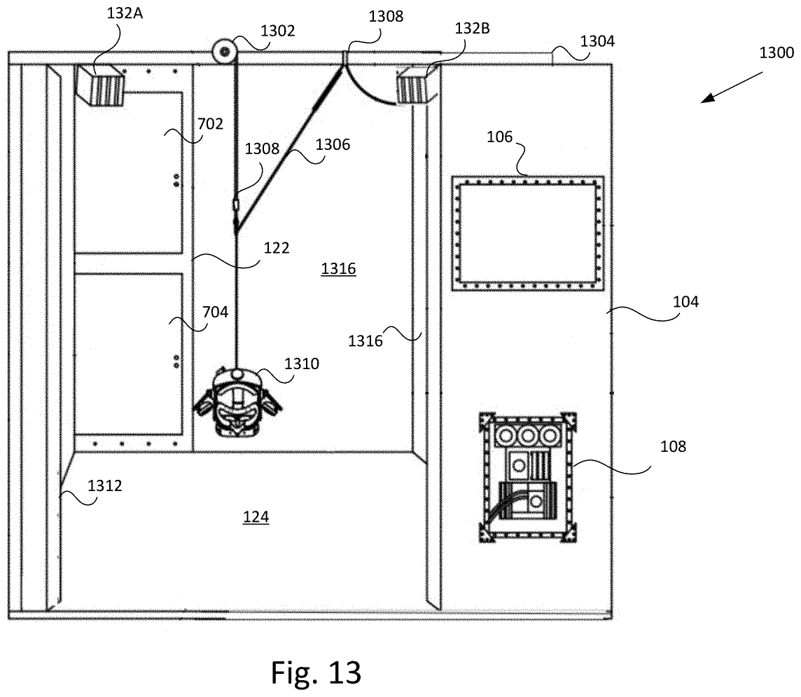

FIG. 13 illustrates another embodiment of a mobile unit 1300. Mobile unit 1300 is similar to mobile unit 100 discussed above, and as such, like features will be given identical numbers and not discussed further herein, such as the monitor 106 and computer 108. Similar to mobile unit 100, mobile unit 1300 is modular in from such that it can be deconstructed into a series of wall panels and reconstructed into a virtual reality experience unit. Unlike mobile unit 100, however, the wall panels of mobile unit 1300 may include fabric to reduce the size and weight of the mobile unit 1300 when shipped.

Mobile unit 1300 may include a cable management dispenser 1302, which can be attached to a cable management beam 1304. A cable 1306 is wound through the cable management dispenser 1302 and may include a number of clasps 1308 to attach the cable 1306 to the cable management beam 1304, as well as the cable 1306 wound in the cable management dispenser 1304. The cable 1306 can be attached to a virtual reality helmet 1310 though an electrical connection, such as, but not limited to, a high-definition multimedia interface (HDMI) electrical connection.

Mobile unit 1300 may also include a support beam 1312 for supporting the opening of the mobile unit 1300. As mentioned above, wall panels 1314, 1316, and 1318 may be similar to wall panels 110, 112, 114, 116, 118, and 120 of FIG. 1. That is, wall panels 1314, 1316, and 1318 may be composed of multiple wall panels and may include modular attachment hinges 200 and 202 to connect each of the walls. Further, more than three wall panels 1314, 1316, and 1318 may be used in mobile unit 1300.

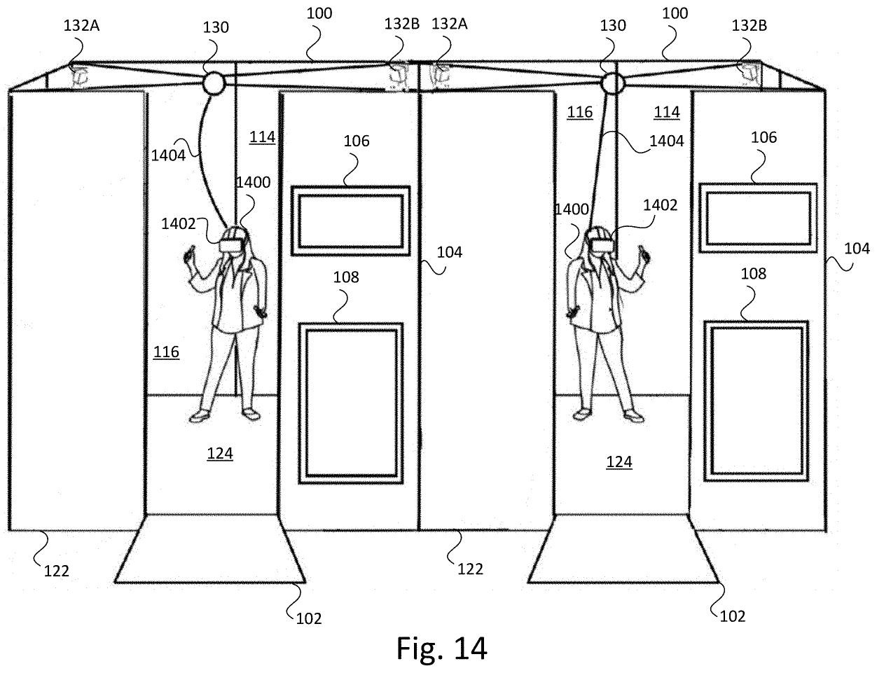

In some embodiments, multiple mobile units may be connected to each other to create a multi-player virtual reality system in some embodiments. For example, FIG. 14 illustrates two mobile units 100 connected to each other for a multiplayer experience. As can be seen in FIG. 14, two players 1400 are each in a mobile unit 100 and each are wearing a virtual reality helmet 1402 connected by a cable 1404 to the cable management ring 130. When two mobile units are connected, such as mobile units 100 shown in FIG. 14, only a single wall panel is needed between the mobile units 100 to separate the mobile units 100. That is, the two mobile units 100 will share a single wall.

Although two mobile units 100 are shown in FIG. 14, it will be readily understood by a person of ordinary skill in the art that two mobile units 1000 or two mobile units 1300, or any combination thereof, may be connected in a similar manner.

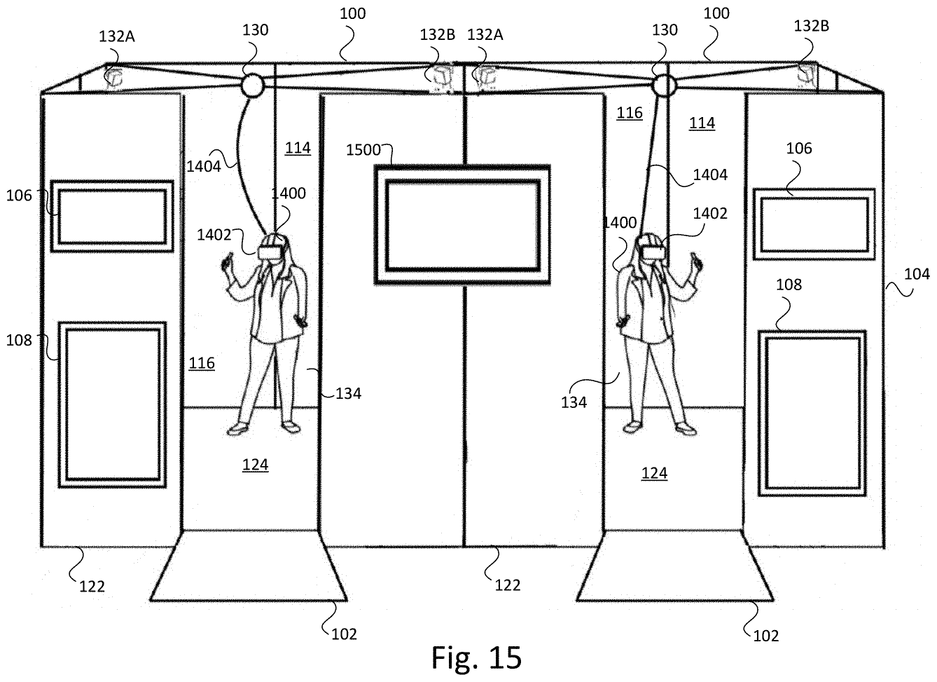

In some embodiments of the disclosure, a monitor 1500 may be provided between the two connected mobile units. As illustrated in FIG. 15, mobile units 100 are connected, similar to that discussed above with respect to FIG. 14, but a monitor 1500 is provided between the two mobile units 100 and the control tower 104 for the unit shown on the left is moved to the far left wall. This allows the monitor 1500 to be attached to the walls of the mobile units 100.

The monitor 1500 may electrically connect to a computer system, either one or both of the computers in the computer system 108, or to another computer system connected to the mobile units.

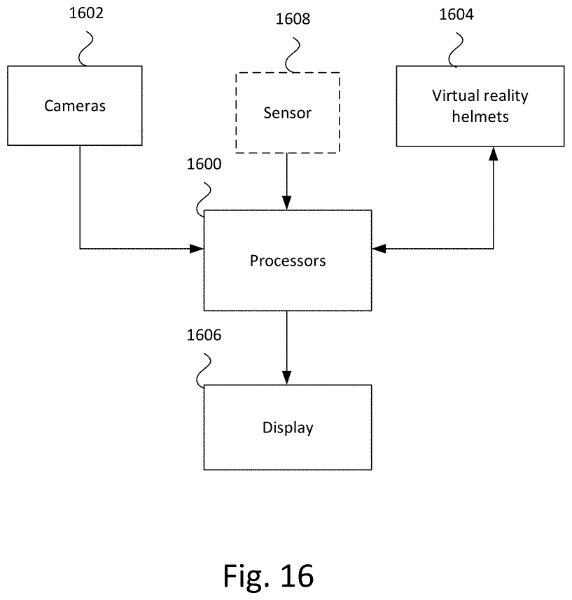

FIG. 16 illustrates a block diagram of a system used for generating a mixed reality image or video using any one of the mobile units 100, 1000, or 1300. One or more processors 1600 are connected to one or more cameras 1602 within the mobile units, as discussed above in the various embodiments. The one or more processors 1600 are also connected to one or more virtual reality helmets 1604 and a display 1606.

A mixed reality system may provide a better experiences for spectators watching players within the mobile units 100, 1000, or 1300. As seen in the mobile units 100, 1000, or 1300, an opening is provided to allow spectators to see the players as they engage with the virtual reality experience. The display 1606, which may be any one of displays 106, 1008, or 1500 discussed above, can allow a spectator to see a mixed reality image of the player in the virtual reality environment that the player also sees through the virtual reality helmet 1604.

The one or more processors 1600 can generate a mixed reality by receiving a virtual reality experience, either from the virtual reality helmet 1604 or from a connected processor 1600, or both, and an image from the one or more cameras 1602. The one or more processors 1600 can combine the images from the one or more cameras 1602 with the virtual reality experience to generate a composite image showing an image of the player within the virtual reality experience.

In the composited image or video, the one or more processors 1600 can generate the composite image or video to show virtual objects being held or otherwise manipulated by the player, as well as the virtual clothing being worn by the player. These objects or clothing may move with the player and show how the player is interacting in the virtual world. In some embodiments, using chroma key technology, the one or more processors 1600 may cleanly separate the player from the real environment so that the composite image with the virtual reality environment can be generated. For example, the virtual player may be depicted on the display 1606 in a virtual environment of walking across a suspension bridge high above a canyon, while the player is physically present in the mobile unit 100, 1000, or 1300. A spectator outside the mobile unit 100, 1000, or 1300 could simultaneously see the physical player through the opening 134, as well as observe the generated virtual depiction on the display 1606. Such an arrangement allows the outside spectator to have his or her own experience separate from the player.

This may be done by using one or more monochrome walls in the mobile unit, as mentioned above. Portions of the video signal from the cameras 1602 that differ from the background color are extracted from the video by the one or more processors 1600 and superimposed on the virtual reality video or experience.

In some embodiments, the cameras 1602 may be depth cameras, which may be used in conjunction with visual light cameras 1602 to facilitate the identification of the image of the player and separate it from the background by the one or more processors 1600. If depth and visual light cameras 1602 are used, the interior portion of the wall panels do not need to be a monochrome color.

The one or more processors 1600 may generate instructions to the display 1606 to display multiple windows simultaneously on the display, each window showing a different virtual reality or mixed reality video stream. Multiple windows can allow multiplayers to be shown on a single display 1606. For example, if two mobile units are present, a player on a left side mobile unit may be shown in a composite image or video in a left window on the display 1606, while the player in the right mobile unit is shown in a composite image or video in a right window of the display 1606.

Although FIG. 16 shows a single camera 1602 and virtual reality helmet 1604, multiple cameras 1602 may be connected to the one or more processors 1600, as well as multiple virtual reality helmets 1604. Then, the one or more processors 1600 may instruct the display 1606 to display a composite image of one player and their virtual reality environment in one window of the display 1606 and display another composite image of a second player and their virtual reality environment in a second window of the display 1606 or in a separate display 1606. If additional players and mobile units are added, more windows may be provided on the display 1606. In some embodiments, multiple displays 1606 may also be used, each display showing a different composite image of a player and a virtual reality environment, or multiple windows.

Further, as discussed above with mobile units 100, 1000, and 1300, multiple cameras 1602 may be used in a single interior area, and the one or more processors 1600 may automatically select which camera 1602 to use to generate the composite image, or the display 1606 may include a user interface to allow a player and/or operator to select which camera 1602 to use. In some embodiments, a separate user interface display may be provided to connect to the one or more processors 1600.

In some embodiments, multiple cameras may be selected simultaneously from a single interior area of a mobile unit 100, 1000, or 1300. For example, a camera 1602 from in front of a player and a camera 1602 from a side of a player may be selected, and the one or more processors 1600 may generate in different windows of the display 1606 each composite image using the two cameras 1602 respectively.

An optional sensor 1608 may be used to acquire an orientation of the virtual reality helmet 1604. Depending on the virtual reality content being shown through the virtual reality helmet 1604, a main direction in which the player primarily faces in the virtual reality space may be known. This direction can be used to orient the interior area of the mobile units 100, 1000, and 1300, so that the player is encouraged to orient themselves to be best observed by the one or more cameras 1602 in the interior area.

When multiple mobile units are connected, the two players can be encouraged to face the same direction using this known orientation. In other embodiments, the main direction may be set in each mobile unit so that each of the players are facing each other, independent of whether or not there is an intervening wall. In some embodiments, the cameras 1602 are oriented so that anything outside an interior of the play area is not visible by the cameras 1602. This results in the best composite image generated by the one or more processors 1600. In some embodiments, a camera 1602 may be positioned in the interior area along the same wall as the display 1606. Using a camera 1602 in this position to create the composite image, allows a spectator to view the composite image in the same orientation as the player in the interior area of the mobile unit 100, 1000, or 1300. That is, both the composite image and the opening would show the back of a player.

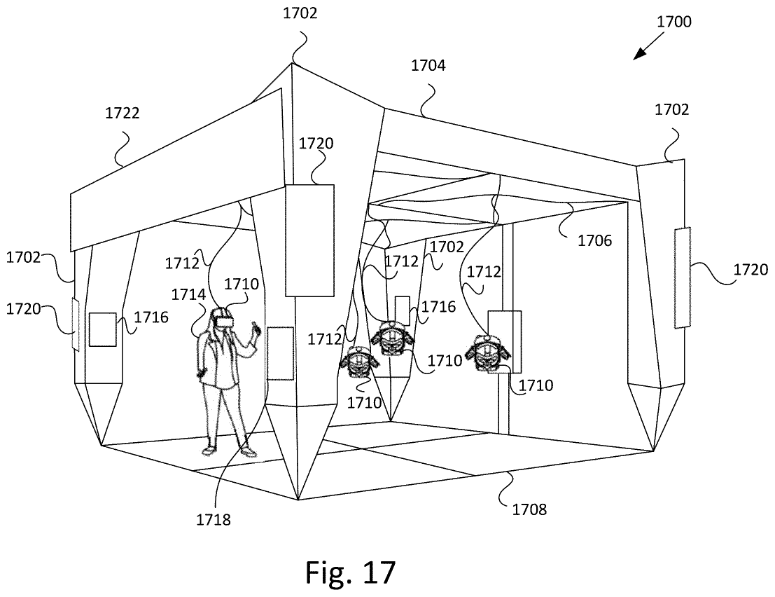

As illustrated in FIG. 17, exterior walls are not required in some embodiments. FIG. 17 illustrates a four-player environment. In this embodiment, the virtual reality system 1700 does not include any interior walls. Rather, four columns or pillars 1702 located at each corner of the virtual reality system 1700 may be provided to support a ceiling 1704, as well as cable management systems 1706. Note that additional columns may exist between adjacent two pillars 1702 to define two interior areas and further support the ceiling 1704. A separate cable management system 1706 is provided for each player. In the case of FIG. 17, four cable management systems 1706 are provided. However, more or less than four play areas may be provided using the virtual reality system 1700. A floor area 1708 is provided for each player, as well as a helmet 1710 connected to a cable 1712 for each player. In FIG. 17, one player 1714 is shown wearing a helmet 1710, and three other helmets are provided 1710 for other players if present. The lack of walls between the play spaces allow spectators to view all four players simultaneously and easy to step inside the virtual reality system for quick setup.

The columns or pillars 1702 may be arranged to face only one player's play space. A display 1716 may then be installed on each pillar 1702 to correspond to the virtual image seen by the player positioned closest to the pillar 1702. Those displays 1716 may be substantially facing towards the center of the virtual reality system 1700 in horizontal plane, so that the operator standing inside the virtual reality system 1700 could check all players see the proper virtual image without moving. This may allow the operator to confirm the system is working as intended.

Each column 1702 may also include a computer system device 1718 for a player to connect to and/or set up their virtual reality experience. In FIG. 17, only one computer system device 1718 is shown due to the angle of FIG. 17. However, a computer system device 1718 may be provided on each column 1702.

An outside display 1720 may also be provided on each column 1702 to provide an image to a spectator, which may be a composite image as discussed above. Although not shown, an interior side of each pillar 1702 may include a camera 1602, as discussed above, to take an image of the player, which may be used to create a composite image. Additional display 1722 may be added to the virtual reality system 1700 for showing additional mixed reality images or any other images, such as advertisements. Those displays 1720 and display 1722 may be facing outside the virtual reality system 1700 to attract spectators.

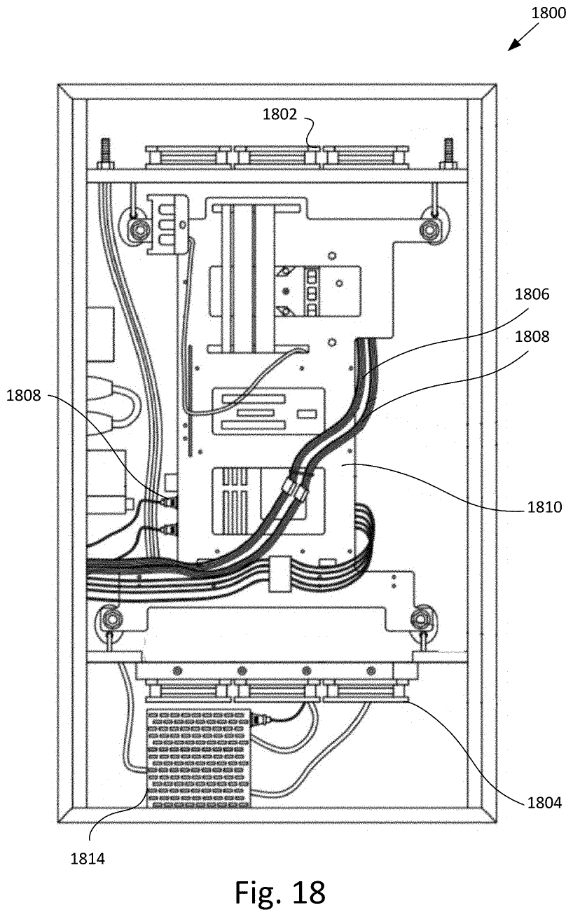

FIG. 18 is an example of a computer system 1800 that may be used for any of computer systems discussed above, such as computer system 108, 1016, or 1716. Computer system 1800 is a wireless unit which can enable public facing multi-player virtual reality experiences. The computer system 1800 may include, for example, an upper cooling system 1802, a lower cooling system 1804, connections 1806 to and from a player's virtual reality system or helmet, and connections 1808 to and from a computer 1810, and a power strip 1814, as will be understood by one skilled in the art.

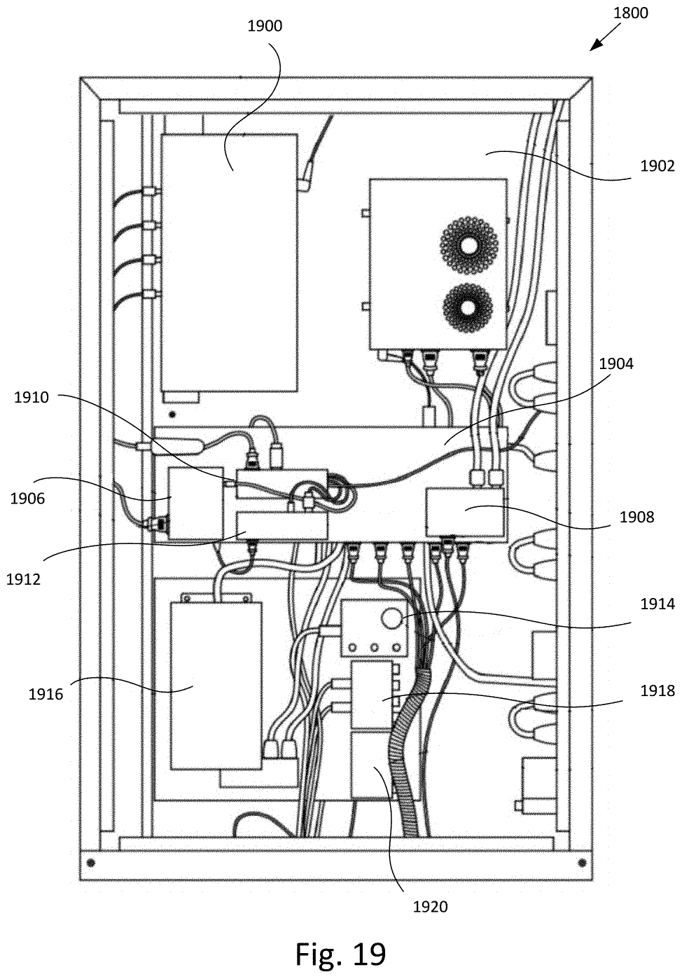

FIG. 19 illustrates a backside of the computer system 1800, which may include, for example, a network switch board 1900, servers for content, connections to content distribution networks, and connections to third and first party services 1902, as well as a keyboard, video, and mouse box 1904. There may also be signal splitters 1906 and 1908 for video, audio, and communications. Two miniature computers sticks 1910 and 1912 may be used for peripherals and other screes. An effects controller 1914 may also be provided for the optional implementation of effects, such as lighting on either the computer system 1800 itself or other equipment located in the virtual reality mobile units. An effects power supply 1916 and two effects recorders 1918 and 1920 may also be provided.

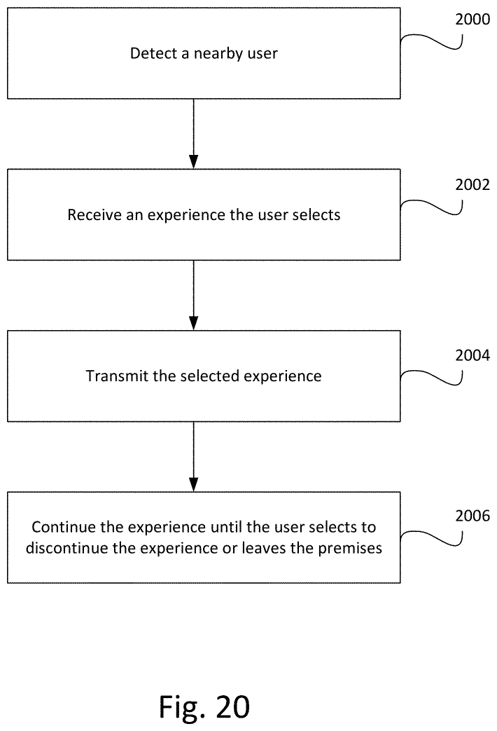

As mentioned above, the computer system 1800 may be used to enable public facing virtual reality experiences. FIG. 20 is a flow chart illustrating an operation for selecting a virtual reality experience by a player. When the computer system 1800 is turned on, the computer system 1800 using one or more processors in the computer 1810 may be able to detect in operation 2000 a nearby player based on either a sensor worn by the player or a signal sent from a player's mobile device, such as a tablet or cellular phone. Using a user input, which may be the player's mobile device and/or a user input connected to the computer system 1800, a player may select an experience, which is then received in operation 2002 by the computer system 1800.

The selected player experience is then transmitted by the computer system 1800 to a player's virtual reality helmet in operation 2004. The player may begin the virtual reality experience using the virtual reality helmet. In operation 2006, the computer system 1800 discontinues the selected virtual reality experience when a discontinuation signal is received. The discontinuation signal may be generated when the player selects to discontinue through the user input, or if the computer system 1800 is no longer able to detect the player through either the sensor or the player's mobile device.

The computer system 1800 may be connected to multiple virtual reality helmets to facilitate a number of different virtual reality experiences at the same time. In some embodiments, each mobile unit 100, 1000, or 1300 is provided with its own computer system 1800, while in other embodiments, a single computer system 1800 is provided to facilitate the virtual reality experiences for all connected mobile units.

In some embodiments, the computer system 1800 may receive biometric data from a player wearing one or more biometric sensors. The biometric data may include a heart rate and/or body temperature, and convert the data into audio visual content that can be displayed through the virtual reality helmet. The biometric data may be continually collected and converted, so that the biometric responses to the audio visual content from the biometric data conversion shows to the player are also captured and converted into more audio visual and other responses.

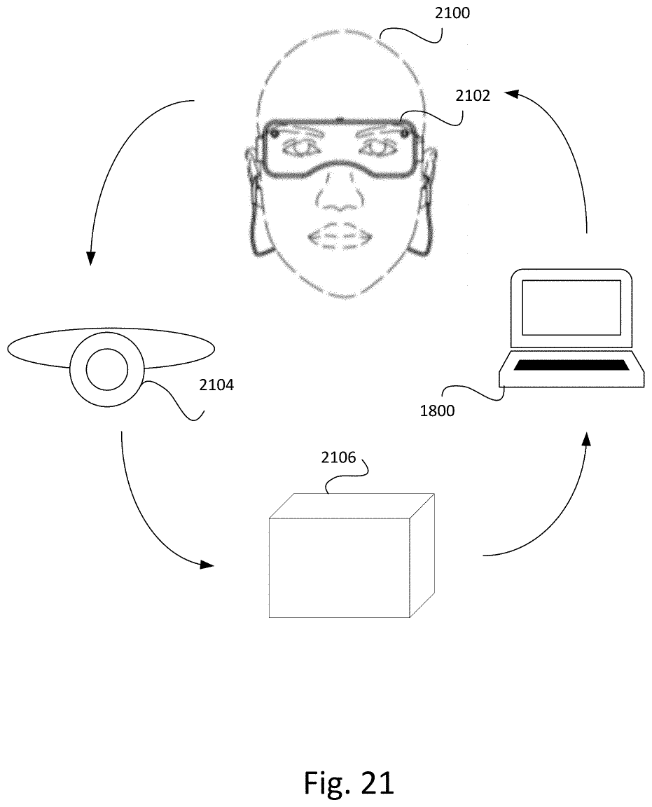

FIG. 21 illustrates the conversion of biometric data to audio visual content. Typically, a player 2100 will wear a biometric sensor 2104 on his or her body, such as on the wrist of a player 2100. The biometric sensor 2104 transmits biometric data to a data conversion unit 2106, which may be located in the computer system 1800 in some embodiments. In other embodiments, the data conversion unit 2106 may be separate from the computer system 1800. The data conversion unit 2106 then converts the biometric data to audio visual content and transmits this data to the computer system 1800, which can then add this information into the virtual reality experience sent to the helmet 2102 of the player 2100.

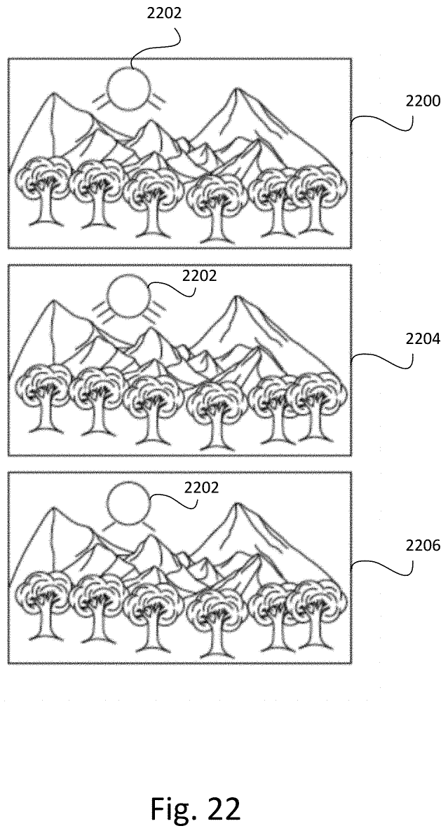

FIG. 22 illustrates an example of how the audio visual content generated by the data conversion unit 2106 from the biometric data may be used in the virtual reality system or experience. Picture 2200 shows an example of a virtual audio visual environment which may be shown to a player through the helmet 2102 before the detection, conversion, and transmission of player's biometric data into a new virtual audio visual content. In the picture, the sun 2202 may be a particular brightness or moving at a particular speed.

If a player selects to amplify the biometric data, as will be discussed in more detail below, the virtual environment changed from picture 2200 to picture 2204, which amplifies the scene based on the biometric data of the player. For example, the sun 2202 may change brightness and/or speed in response to the biometric data of the player. For example, in picture 2204, biometric data has indicated that the player is excited, so the picture 2204 is amplified, for example, by either brightening the sun 2202 or increasing the movement speed of the sun 2202. Alternatively, if a player select to abate the biometric data, picture 2206 illustrates that a scene shown through the helmet 2102 would become more audio visually soothing if a player's biometric data indicated a player's excitement. In this example, the brightness of the sun 2202 or speed the sun is moving 2202 may be lowered to accommodate the excitement of the player.

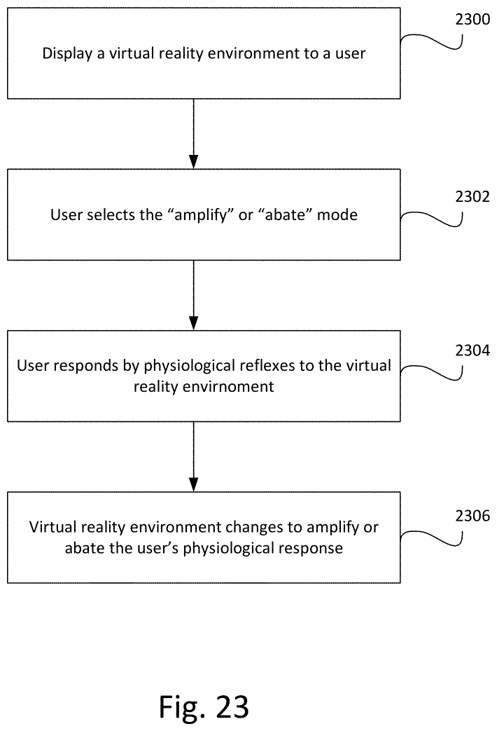

Using a user input, a player may select to either amplify or abate the audio visual content generated by the data conversion unit 2106. FIG. 23 is a flow chart illustrating an operation from a player's perspective when using the biometric data as part of the virtual reality experience. Initially, in operation 2300, a virtual reality environment is displayed to the player in the helmet 2102. Using virtual reality equipment or any other user input, a player may then select in operation 2302 whether to use the biometric data, and, if so, in an abate or amplify mode.

In operation 2304, a player beings the virtual experience and responds to the virtual reality experience by physiological reflexes. In operation 2306, based on audio visual content from the data conversion unit 2106, the virtual reality experience is changed to either amplify or abate the player's physiological response, depending on the selection of the player in operation 2302.

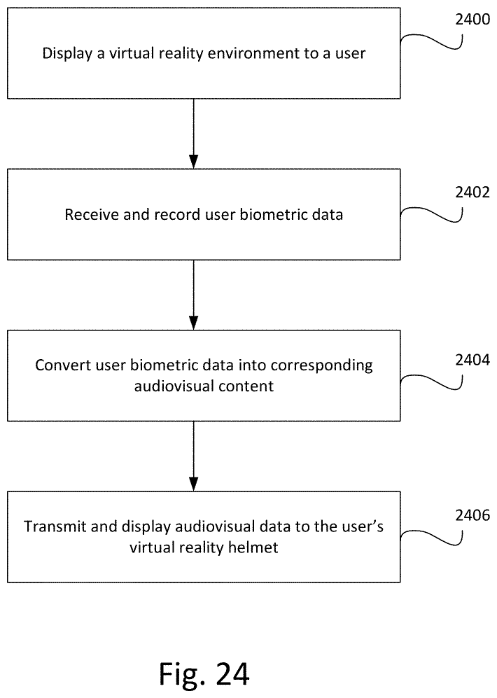

FIG. 24 is a flow chart illustrating an operation for converting the biometric data. In operation 2400, a virtual reality experience is displayed to a player in the helmet 2102. Using the biometric sensor 2104, biometric data is received and recorded in the data conversion unit 2106 in operation 2402.

The data conversion unit 2106 may then convert the biometric data received into corresponding audio visual content in operation 2404. This audio visual content may then be transmitted to the computer system 1800 to add this audio visual content to the virtual reality experience and transmit the new virtual reality experience to the helmet 2102. The process then continues by returning to operation 2402 to receive and record more player biometric data.

Embodiments of the disclosure are not limited to the biometric data being used only in the virtual reality experiences displayed in the helmets 2102. This biometric data may also be used to modify the mixed reality content that is displayed to a spectator on a monitor, as discussed above. In some embodiments, monitors for the spectators may show the same audio visual content that is displayed to the player in the helmet 2102.

However, in other embodiments, audio visual content may be generated based on the biometric data to include content shown on the display, lighting of the players within the virtual reality system, lighting of the mobile devices themselves, or content and/or volume of a soundtrack of sound effects directed to the spectators.

Biometric data is also not limited to being used solely by the player of the virtual reality system. Rather, biometric sensors may be worn by spectators, or other data may be measured, such as volume level or amount of activity, which may be input into the data conversion unit 2106 and also converted to audio visual data which can be displayed both to the player in the virtual reality experience, as well as in the mixed reality images shown to the spectators. The spectator biometric data may also be used to amplify or abate the virtual reality experience of the player.

In some embodiments, rather than using biometric data, other data collected may be converted to audio visual content in the data conversion unit 2106. For example, the status of a player's preparation for starting to the virtual reality experience may be detected, such as completion of mounting of the helmet 2102 or grabbing/holding hand-controllers, and this detected data may be converted in the data conversion unit 2102 to audio visual content as well.

For example, an audio visual content directed to the spectators operates in abate mode before the completion of the virtual reality player's preparation. In this mode, the mood of the audio may be contemplative with a relatively low volume. However, once the virtual reality player's preparation is detected as complete, the audio visual content may be generated to amply mode, which may play upbeat music at a higher volume.

In some embodiments of the disclosure, biometric data such as, but not limited to, fingerprints, voice recognition, and/or iris recognition may be used to limit what experiences may be used by the player of the virtual reality system. For example, certain experiences, such as gambling or graphic experiences, may only be available to players of a particular age. Identifying information of a player may be stored in a database, which the computer system 1800 may access. While embodiments discussed below will use a fingerprint authentication device for ease of discussion, a voice recognition or iris recognition device may be used instead or in combination with the fingerprint authentication device.

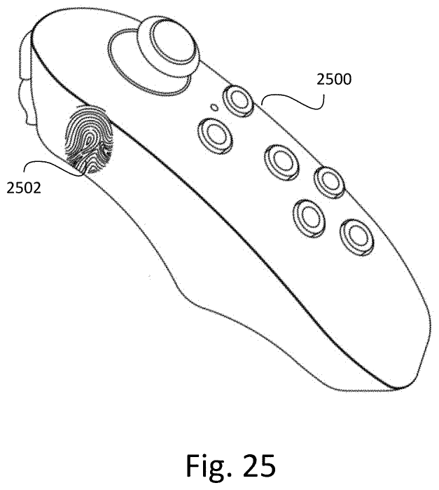

FIG. 25 illustrates an example of a fingerprint detection device 2502 which may be included in a hand-controller 2500 of the virtual reality experience. While the fingerprint detection device 2502 is shown on the hand-controller 2500, embodiments of the disclosure are not limited to this. The fingerprint detection device 2502, or any other authentication device, may be placed, for example, in a user input or on a helmet 2102.

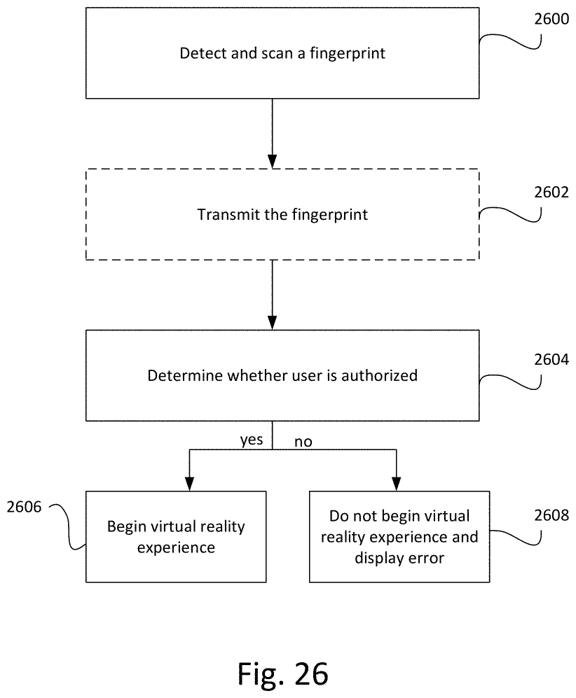

FIG. 26 is a flow chart illustrating an operation for authenticating a player for various virtual reality experiences. Initially, in operation 2600, the fingerprint detection device 2502 detects and scans a fingerprint of a player. In some option embodiments, in operation 2602, the fingerprint may be transmitted by the fingerprint detection device 2502 to a processor, such as a processor in computer system 1800. In other embodiments, the fingerprint detection device 2502 may include a processor.

In operation 2604, a processor then compares the fingerprint to a database of fingerprints of authorized players. If the player is authorized, then in operation 2606, the virtual reality experience can begin. If the player is not authorized, then in operation 2608, the virtual reality experience does not begin and in some embodiments, a message may be displayed to the player letting the player know they do not have access.

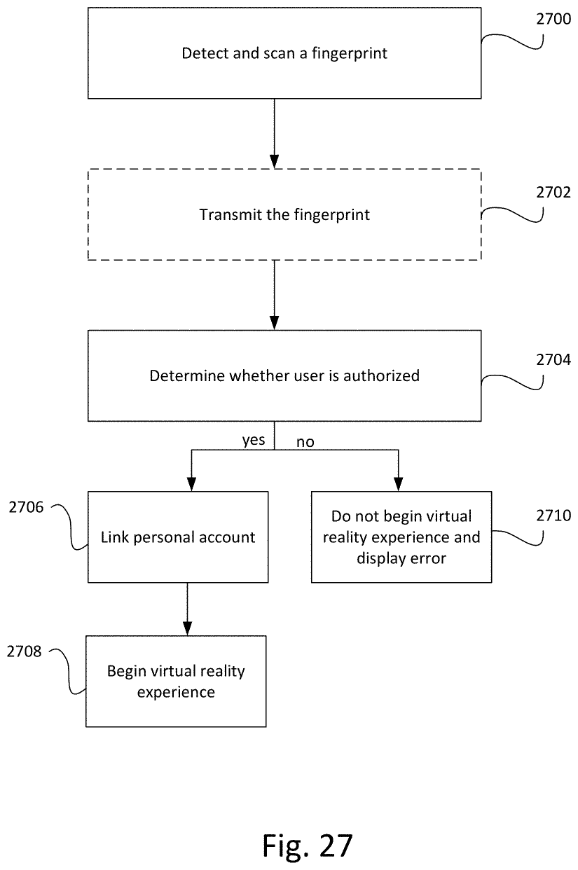

In some embodiments, a player may link personal accounts to his or her detected fingerprint. For example, in the flow chart illustrated in FIG. 27, initially in operation 2700, a player's fingerprint is detected and scanned. In optional operation 2702, the fingerprint may be transmitted to a remote processors. In operation 2704, the processor determines if a player is located in the database. If yes, then a player can link a personal account in operation 2706, such as a bank account. In operation 2708, the player begins the virtual reality experience and can use his or her personal account in the experience, if desired. In operation 2710, the virtual reality experience does not begin if a player is not in the database. Although not shown in FIG. 27, a player may have an option to add themselves to the database at this stage, or the player may be able to be added to the database through an operator of the virtual reality system.

As mentioned above, since a player may link a personal account, such as a bank account, it can be beneficial to allow a player to make purchases during the virtual reality experience. This may be done by confirming the purchase with the fingerprint detection device 2502. By allowing the purchase through the fingerprint detection device 2502, a player's immersion in the virtual reality experience is not compromised.

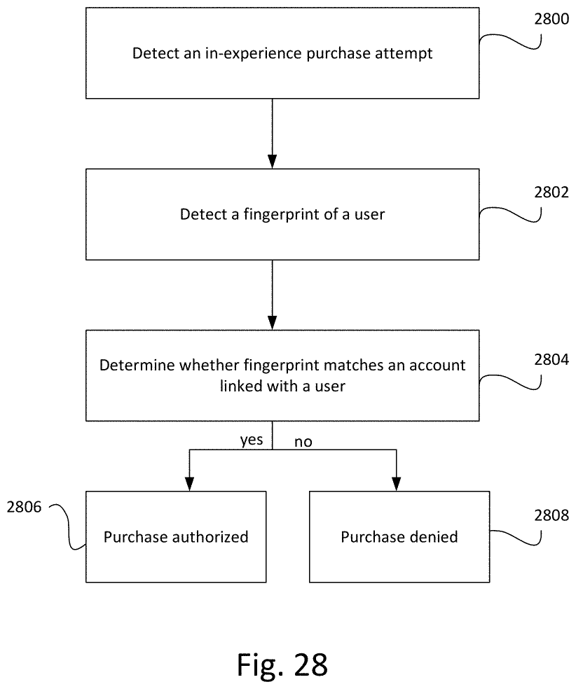

FIG. 28 is a flow chart illustrating an operation of a purchase by a player in the virtual reality experience. The computer system 1800 or any other processor attached to the virtual reality experience may detect an in-experience purchase attempt in operation 2800. In operation 2802, a fingerprint of a player is detected. A processor in operation 2804 can determine whether the fingerprint matches a personal account linked with the player. If yes, then in operation 2806, the purchase is authorized. If not, then in operation 2808, the purchase will be denied.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

We claim:

1. A virtual reality system, comprising:
one or more modular walls configured to define an interior area, at least one modular wall having a monochromatic interior surface;
a camera positioned within the interior area, the camera configured to capture an image of a player with the monochromatic interior surface as a background;
one or more processors configured to generate a virtual scene, to receive the image of the player, and generate a composed image including at least a portion of the image of the player composited into the virtual scene; and
a display configured to receive and display the composed image.

2. The virtual reality system of claim 1, wherein the interior area is a first interior area and the one or more modular walls are configured to define a second interior area, at least one modular wall of the second interior area having a second monochromatic interior surface.

3. The virtual reality system of claim 2, wherein the camera is a first camera, the virtual reality system further comprising a second camera positioned within the second interior area, the second camera configured to capture an image of a second player with the second monochromatic interior surface as a background.

4. The virtual reality system of claim 3, wherein the composite image is a first composite image and the virtual scene is a first virtual scene, wherein the one or more processors are further configured to generate a second virtual scene, to receive the second image of the second player, and generate a second composite image including at least a portion of the second image of the player composited into the second virtual scene.

5. The virtual reality system of claim 4, wherein the display is configured to simultaneously display the first composite image and the second composite image.

6. The virtual reality system of claim 1, wherein the camera is a depth-camera.

7. The virtual reality system of claim 1, further comprising a biometric sensor configured to output biometric data, wherein the one or more processors are further configured to receive the biometric data and output audio visual data.

8. The virtual reality system of claim 7, wherein the one or more processors are further configured to modify the virtual scene based on the audio visual data.

9. The virtual reality system of claim 8, wherein the audio visual data amplifies the virtual scene.

10. The virtual reality system of claim 8, wherein the audio visual data abates the virtual scene.

11. The virtual reality system of claim 7, wherein the one or more processors are further configured to modify lights or speakers based on the audio visual data.

12. The virtual reality system of claim 11, wherein the audio visual data amplifies lights or speakers based on the audio visual data.

13. The virtual reality system of claim 11, wherein the audio visual data abates the lights or speakers based on the audio visual data.

14. The virtual reality system of claim 1, further comprising an authentication device.

15. The virtual reality system of claim 14, wherein the authentication device is a fingerprint detector, a voice detector, or an iris detector.

16. The virtual reality system of claim 14, wherein the one or more processors are configured to receive an output from the authentication device and determine if a player is authorized.

17. The virtual reality system of claim 14, wherein the one or more processors are configured to receive an output from the authentication device and determine if a player is authorized to make a purchase.

18. The virtual reality system of claim 1, wherein the one or more modular walls are one or more pillars.

19. The virtual reality system of claim 1, wherein the one or more processors are configured to detect a nearby player, to receive an experience from the nearby player, and output the virtual scene based on the received experience.

20. The virtual reality system of claim 19, wherein the one or more processors are configured to discontinue the virtual scene when the nearby player is no longer detected.

21. A virtual reality structure, comprising:
one or more modular walls configured to define an interior area having an opening;
one or more processors configured to generate a virtual scene;
a first display showing the virtual scene positioned on an interior portion of at least one of one or more modular walls and substantially facing towards the center of the virtual reality structure in a horizontal plane; and
a second display showing the virtual scene and facing outside of the virtual reality structure.

22. The virtual reality structure of claim 21, wherein the one or more modular walls includes four pillars, each located at corners of the virtual reality structure, and wherein the first display includes multiple displays each positioned at one of the four pillars.

23. The virtual reality structure of claim 21, wherein the one or more modular walls are configured to define two interior areas, each interior area having an opening.

24. The virtual reality structure of claim 23, wherein the second display is positioned on an exterior portion of at least one of the one or more modular walls adjacent to each opening.
